(19) United States
(12) Patent Application Publication
(10) Pub. No.: US 2026/0270077 A1
(43) Pub. Date: Sep. 10, 2026

(54) TIME AND GEOGRAPHICAL DIVERSITY-BASED SYMMETRIC CRYPTOGRAPHY FOR PROTECTING INFORMATION

(71) Applicant: QUALCOMM Incorporated, San Diego, CA (US)

(72) Inventors: William WHYTE, Natick, MA (US); Virendra KUMAR, Sudbury, MA (US); Vincent Douglas PARK, Alexandria, VA (US); James Alan MISENER, San Diego, CA (US); Sean Vincent MASCHUE, Encinitas, CA (US)

(21) Appl. No.: 19/559,804

(22) Filed: Mar. 6, 2026

Related U.S. Application Data
(60) Provisional application No. 63/769,709, filed on Mar. 10, 2025.

(51) Int. Cl. H04L 9/32; H04L 9/08; H04W 12/63

(52) U.S. Cl. CPC H04L 9/3242; H04L 9/088; H04L 9/3255; H04W 12/63

(57) ABSTRACT

Disclosed are systems and techniques for time and geographic diversity-based for symmetric cryptography for protecting communications. For example, a device can transmit, while in a first geographic tile associated with a first group key used by wireless devices within the first geographic tile, a first application message and a first authentication code to one or more wireless devices, wherein the first authentication code is generated based on cryptographic transformation of the first group key to the first application message, and receive, while in the first geographic tile, a second application message and a second authentication code from a first wireless device located in a second geographic tile associated with a second group key, wherein the second authentication code is generated based on application of the second group key to the second application message.

### CROSS REFERENCE TO RELATED PATENT APPLICATION

This application claims priority to U.S. Provisional Patent Application Ser. No. 63/769,709 titled “TIME AND GEOGRAPHICAL DIVERSITY-BASED SYMMETRIC ENCRYPTION FOR PROTECTING INFORMATION,” filed on Mar. 10, 2025, which is incorporated herein by reference in its entirety for all purposes.

### FIELD

The present disclosure generally relates to protecting information using cryptographic functions. For example, aspects of the present disclosure relate to time and geographical diversity-based techniques for symmetric cryptography for protecting communications (e.g., V2X communications, such as V2X messages).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards and in intelligent transportation systems standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Aspects of wireless communication may comprise direct communication between devices, such as in V2X, vehicle-to-vehicle (V2V), and/or device-to-device (D2D) communication. There exists a need for further improvements in V2X, V2V, and/or D2D technology. These improvements may also be applicable to other multi-access technologies and the telecommunication standards that employ these technologies.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods, and computer-readable media for wireless communication. According to at least one example, a method is provided for trusting wireless devices in V2X communication network. The method includes: transmitting, while in a first geographic tile associated with a first group key, a first application message and a first authentication code to one or more wireless devices, wherein the first authentication code is generated based on application of the first group key to the first application message; and receiving, while in the first geographic tile, a second application message and a second authentication code from a first wireless device located in a second geographic tile associated with a second group key, wherein the second authentication code is generated based on application of the second group key to the second application message.

In another example, an apparatus is provided that includes a memory (e.g., a memory configured to store data, such as virtual content data, one or more images, etc.) and a processor (e.g., implemented in circuitry) connected to the memory and configured to execute instructions and, in conjunction with various components (e.g., a network interface, a display, an output device, etc.), cause the apparatus to: transmit, while in a first geographic tile associated with a first group key, a first application message and a first authentication code to one or more wireless devices, wherein the first authentication code is generated based on application of the first group key to the first application message.

In some aspects, the apparatus is, includes, or is part of, a vehicle (e.g., an automobile, truck, etc., or a component or system of an automobile, truck, etc.) or a device or component of the vehicle, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a robotics device, or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

This summary is not intended to identify key or essential features of the claimed subject matter, nor is it intended for use in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is a diagram of a vehicle and various V2X functions of the vehicle in accordance with some aspects of the disclosure;

FIG. 2 is a diagram illustrating an example wireless communication configuration in accordance with some aspects of the present disclosure;

FIG. 3 is a diagram illustrating an example wireless communications system in accordance with some aspects of the present disclosure;

FIG. 4 is a diagram illustrating an example of a disaggregated base station architecture in accordance with some aspects of the present disclosure;

FIG. 5 is a block diagram illustrating an example of a computing system of a vehicle in accordance with some aspects of the present disclosure;

FIG. 6A is an illustration of geographic tiles of a partial portion of a map in accordance with some aspects of the disclosure;

FIG. 6B illustrates an example communication scenario for geographically diverse symmetric authentication between wireless devices in accordance with some aspects of the disclosure;

FIG. 7 is a timeline illustrating a key rotation and different periods associated with a first key with some aspects of the disclosure;

FIG. 8 is a flow diagram illustrating a process for protecting information using cryptographic functions in accordance with some aspects of the disclosure;

FIG. 9 is a flow diagram illustrating a process for rotating keys in a V2X communication in accordance with some aspects of the disclosure; and

FIG. 10 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Various types of information (e.g., V2X communications, such as V2X messages) can be protected to prevent malicious actors from adversely affecting systems that utilize the information. For example, wireless communications systems are deployed to provide various telecommunication services, including telephony, video, data, messaging, broadcasting, among others. Vehicles are an example of systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems encompass vehicle-to-vehicle (V2V), vehicle-to-infrastructure (V2I), vehicle-to-network (V2N), and vehicle-to-pedestrian (V2P) communications, which are all collectively referred to as vehicle-to-everything (V2X) communications. V2X communications is a vehicular communication system that supports the wireless transfer of information from a vehicle to other entities (e.g., other vehicles, pedestrians with smart phones, equipped vulnerable road users (VRUs), such as bicyclists, and/or other traffic infrastructure) located within the traffic system that may affect the vehicle. The main purpose of the V2X technology is to improve road safety, fuel savings, and traffic efficiency.

The IEEE 802.11p Standard supports a dedicated short-range communications (DSRC) interface for V 2X wireless communications. Characteristics of the IEEE 802.11p based DSRC interface include low latency and the use of the unlicensed 5.9 Gigahertz (GHz) frequency band. C-V2X was adopted as an alternative to using the IEEE 802.11p based DSRC interface for the wireless communications. The 5G Automotive Association (5GAA) supports the use of C-V2X technology. In some cases, the C-V2X technology uses Long-Term Evolution (LTE) as the underlying technology, and the C-V2X functionalities are based on the LTE technology. C-V2X includes a plurality of operational modes. One of the operational modes allows for direct wireless communication between vehicles over the LTE sidelink PC5 interface. Similar to the IEEE 802.11p based DSRC interface, the LTE C-V2X sidelink PC5 interface operates over the 5.9 GHz frequency band. Vehicle-based messages, such as Basic Safety Messages (BSMs) and Cooperative Awareness Messages (CAMs), which are application layer messages, are designed to be wirelessly broadcasted over the 802.11p based DSRC interface and the LTE C-V2X sidelink PC5 interface.

Malicious actors can adversely affect traffic in a V2X system and can increase congestion, cause collisions involving autonomous collisions, cause phantom vehicles to be present in the network to affect traffic, interfere with vehicle safety and increase safety risks, grant unauthorized access to vehicle systems, and so forth. Strong cryptography may be necessary to protect the various types of information. For example, strong cryptography may be needed for protecting V2X communication to ensure that autonomous and semi-autonomous systems work safely, reduce congestion, and provide efficient usage of traffic infrastructure.

Conventional cryptographic techniques use hard problems in number theory as the mathematical basis for encryption algorithms such as Elliptic Curve Cryptography (ECC) and RSA (Rivest-Shamir-Adelman). Hard problems in number theory are the basis of classical cryptography because the algorithms compute in one direction but are extremely hard to reverse without a special key. For example, hard problems include integer factorization, discrete logarithms, and elliptic curve mathematics. The difficulty of solving these problems ensures the security of cryptographic schemes against attacks using conventional processors.

In some aspects, quantum computers can break classical cryptography (e.g., hard problems in number theory such as integer factorization, discrete logarithms, and elliptic curve mathematics) by solving problems that are computationally infeasible for classical computers. Shor's algorithm is an example of an algorithm that can be executed on a quantum computer to break classical cryptography. For instance, many communications systems use public-key cryptography to secure communications. Once quantum computers of sufficient capabilities (e.g., Cryptographically Relevant Quantum Computers, CRQC) are available, they will be able to break the most common currently used public-key cryptography algorithms. For example, given a public key for one of the available public-key cryptography algorithms, a CRQC will be able to obtain the private key in a certain amount of time (though not necessarily instantaneously). Having the private key will allow an attacker to decrypt messages, forge signatures, etc., so these algorithms will be unsuitable for use if the data they need to protect (e.g., by encrypting or authenticating it) has a lifetime longer than the expected time it will take an attacker to recover the private key using CRQC.

Alternatives to existing public-key cryptography algorithms exist and some are currently in the process of being standardized by the US National Institute of Standards and Technology (NIST). These algorithms are collectively referred to as post quantum cryptography (PQC). PQC is based on quantum-resistant mathematical foundations that use hard problems that are believed to be difficult for both classical and quantum computers. One example of a hard problem for PQC is a lattice-based problem, which involves finding specific points or structures within a high-dimensional grid (e.g., lattice) that are computationally hard to solve based only on public information. Another example of a hard problem for PQC is code-based cryptography, which relies on the hardness of decoding random linear codes. Code-based cryptography relies on the difficulty of decoding a random linear code and uses a public key generated by selecting a large error-correcting code and applying a series of random invertible transformations. Decoding random codes is exponential in complexity and is resistant to PQC algorithms.

However, it is infeasible to implement PQC for all communications (e.g., V2X communications). For example, V2X communications require low-latency and high-throughput. Current PQC algorithms struggle with low-latency and high-throughput operations due to computational overhead and larger key sizes as compared to classical cryptographic algorithms. In addition, the larger key sizes significantly contribute to bandwidth consumption, which increases latency with V2X communications. In addition, existing infrastructure supporting V2X communications, including roadside units and cellular networks, would require significant upgrades to support PQC without disrupting service.

For example, all of the PQC algorithms currently under consideration have the property that their keys, ciphertexts, and signatures are considerably larger than existing public key algorithms and so require more space to transmit, more memory to process, etc. In some settings, such as V2X direct communications, there are many individual public-key signed messages sent per second and the capacity of the dedicated communications channel (e.g., the spectrum) is limited, so that a significant increase in signature and key size, resulting in a significant increase in packet size, will significantly increase the risks that the channel becomes congested and that messages are not received successfully. For any system for which public key cryptographic overhead is a significant contributor to traffic, the transition to PQC will therefore significantly increase the capacity needed for smooth operation of the system and, if the capacity is fixed and limited, the transition to PQC might make correct operation (to pre-quantum performance goals) difficult or impossible.

For example, a V2X system currently may use public key cryptography to protect messages that are broadcast and intended to be received by multiple recipients. The V2X system can include a feature referred to as misbehavior reporting. For instance, if a sender sends data that is misleading (e.g., incorrect, such as indicating a presence of a vehicle that is not in fact present), then a receiver (e.g., a receiving vehicle, a vulnerable road user (VRU), a roadside unit (RSU), etc.) that recognizes that the data is misleading can create a misbehavior report and send the misbehavior report to a central misbehavior authority (MA). The report identifies the sender and the type of the misbehavior and provides evidence that the MA can use to take enforcement action against the sender. The enforcement action may include restricted sender access to the system, for example by revoking the sender's certificates or suspending certificate issuance (e.g., until the bad sender can demonstrate that the defects that caused the bad data have been addressed).

Such misbehavior management therefore relies on the MA being able to correctly identify the bad sender so that the enforcement activity can target the appropriate sender. The identification is typically carried out using the sender's certificate, which is unique to the sender and which is bound to the specific misbehaving message because each message is signed using the certificate's corresponding private key.

A possible approach to improve communication security is to use symmetric cryptographic techniques (e.g., rather than public key authentication), which are resilient to quantum computing techniques. For example, quantum computers do not have an advantage in breaking symmetric encryption, such as advanced encryption standard (AES). Quantum computers can speed up brute-force attacks on symmetric encryption using Grover's algorithm, reducing the effort from 2ⁿ to 2^{n/2}. However, this reduction in complexity can be countered by doubling the key size (e.g., AES-256 remains secure) in symmetric encryption. Some researchers, and recent (2024) recommendations from NIST and others, suggest that even doubling the key size may be unnecessary and it may be sufficient to continue using a symmetric key at current key lengths to obtain currently acceptable security levels. Grover's algorithm also requires deep quantum circuits that are highly prone to errors and not feasible with current or near-future quantum hardware. One threat of quantum computing as presently known is breaking asymmetric cryptography (RSA, ECC, Diffie-Hellman) using Shor's algorithm, which provides an exponential speedup and may make current public-key cryptosystems obsolete.

Symmetric authentication has lower overhead per packet than do signatures based on public key cryptography. However, reliance on symmetric authentication can lead to increased complexity in key management and can reduce the ability of the system to provide non-repudiation, which is the property that someone other than the original sender and receiver of a message can establish that the message was originally sent by a particular sender (meaning, a sender with sole knowledge of a particular key).

V2X systems use ad hoc networking systems that are decentralized and constantly evolving based on the dynamic nature of transportation systems. PKI (Public Key Infrastructure) is used to address these concerns in ad hoc networks by allowing peer devices to independently verify and use public keys to establish a more secure and trustworthy communication environment, even in the absence of centralized infrastructure. For example, PKI allows trusted communications between two different peer devices that have not previously encountered each other without online key negotiation.

Quantum computers will render public key cryptography algorithms insecure because, as noted above, keys will be breakable in polynomial time. Although PQC signature algorithms are under development and standardization, they introduce significant overhead. For example, each signature size may increase from 100 bytes to 1,300 bytes and certificates increase in size from 100 bytes to 1,800 bytes. In current V2X communications, every message is signed and each sender transmits a certificate approximately twice per second. When cryptographically relevant quantum computers become available, maintaining current security protocols will be impractical unless substantial additional bandwidth or spectrum is allocated.

Systems, apparatuses, electronic devices, methods (also referred to as processes), and computer-readable media (collectively referred to herein as “systems and techniques”) are described herein for time and geographical diversity-based symmetric cryptography for protecting information (e.g., V2X communications, such as V2X messages). The systems and techniques can be used for various types of systems or applications. For example, systems and techniques can be used in a V2X system that uses a combination of PQC and classical cryptography to protect messages that are broadcast and intended to be received by multiple recipients. While various examples described herein refer to vehicle communications (e.g., V2X communications) for illustrative purposes, the systems and techniques can be used for any type of information and systems that utilize such information.

In one illustrative aspect, geographical tiles, which are distinct geographical areas that as a group completely cover some extended geographic area, are configured for group-based symmetrical encryption and authentication in an ad hoc network. Each authenticated wireless device within a specific corresponding geographic tile is configured to communicate with other authenticated wireless devices using a secret (i.e. symmetric) key. Within each geographic tile, a symmetric key is distributed to all authorized wireless devices (e.g., vehicles and infrastructure nodes). An authorized wireless device uses the symmetric key to generate an authentication code for transmitted messages to allow authenticated devices to validate the message integrity and authenticity. Non-limiting examples of the authentication code include a message authentication code (MAC), a digital signature, a keyed hash value, an authentication tag generated using an authenticated encryption scheme, a cryptographic checksum, or another cryptographically generated authentication value. In some aspects, a symmetric key and corresponding operations described below (e.g., key rotation, key discovery) may be protected using PQC cryptography.

Each authorized wireless device also possesses each symmetric key for one or more adjacent geographic tiles (e.g., all adjacent geographic tiles) to add geographic diversity, such as to allow wireless devices (e.g., vehicles, VRU devices, etc.) to travel between geographic tiles. Geographic-based key segmentation prevents large-scale key compromise from affecting wide areas and limits the impact of potential cryptographic breaches. In addition, the symmetric key of a geographic tile is rotated based on static or dynamic conditions to enhance security and mitigate risks associated with key exposure over extended periods. Communication networks increase resistance to emerging cryptographic threats including quantum computing algorithms by leveraging both spatial and temporal diversity in key management.

In some aspects, the condition for rotating, replacing, or updating the symmetric key (e.g., a group key) can be predefined or may be dynamically evaluated criteria. Non-limiting examples of conditions may include time-based conditions (e.g., expiration after a predetermined duration, periodic rotation intervals, or time-of-day schedules), usage-based conditions (e.g., a threshold number of messages transmitted or authenticated using the symmetric key, detected communication volume, or key utilization metrics), location-based conditions (e.g., entry into or exit from a geographic tile, proximity to tile boundaries, or mobility patterns of wireless devices), security-based conditions (e.g., detection of anomalous behavior, suspected key compromise, policy updates, or changes in cryptographic risk levels), and network or system conditions (e.g., changes in network congestion, device enrollment or revocation events, infrastructure status changes, or updates to security policies). The conditions may be evaluated individually or in combination and may be determined by infrastructure devices, wireless devices, or a centralized or distributed key management system.

In some aspects, on startup, a wireless device is configured to obtain the current key in use for the current geographic tile and all neighboring geographic tiles. As the wireless device moves from one geographic tile to another geographical tile, the wireless device requests the keys for the new set of neighboring geographic tiles to ensure that it always has the keys for the geographic tile it is in and all neighboring geographic tiles. For example, the symmetric keys can be provided from other authorized wireless devices within that geographic tile or from a key service of that geographic tile. A key service is a trusted network service configured to maintain a repository of cryptographic keys mapped to geographic tiles and to selectively provision, rotate, validate, and revoke the cryptographic keys for authorized wireless devices.

In some cases, when the wireless device needs to obtain a new symmetric key, either as part of moving into an adjacent geographic tile or as part of a key rotation (e.g., a key change based on time such as during a key rotation window), the wireless device sends out a request for the keys. The request may include an identifier for the geographic tiles for which the keys apply, with an encryption key for a public-key cryptography algorithm, signed by a digital certificate that shows the wireless device is trusted by some authority. In some cases, one or more nearby wireless devices respond to the request with the appropriate key or keys that are encrypted with the provided encryption key.

In some aspects, a wireless device obtains the key for a particular geographic tile from a central key server that it communicates with over a medium other than the direct communications medium used for V2X (e.g., using a sidelink). The device can obtain the keys in advance of entering the geographic tiles.

In some aspects, the symmetric key associated with a geographic tile is rotated to increase security using sidelink or direct communications. In one case, a mechanism is defined that identifies how the key is changed and which wireless device of a geographic tile is responsible for initiating the change. For example, the symmetric key could be changed based on a timer (e.g., 300 seconds) or after the symmetric key is shared with a threshold number of distinct wireless devices (e.g., by a fixed device in the geographic tile). In one example, the wireless device in charge of initiating the change, which is referred to as the change leader, may be a specific fixed device closest to the center of the geographic tile, or some other condition that can be evaluated with minimal communication.

In some aspects, the change leader indicates that the change process has started to other wireless devices in the geographic tile and generates or is provided with the new key (e.g. using a collaborative mechanism with other devices, locally or on the network). The change leader is configured to identify a first deadline t_{change} to initiate the key rotation, a second deadline t_{drop} after t_{change} when the current key is dropped. A third deadline can also be generated for a grace period where the current key can be used between t_{change} and t_{drop}. In some cases, the first deadline and the second deadline may be fixed or calculated based on dynamic conditions. Between the current time and the first deadline t_{change}, authorized wireless devices request the new key in the geographic tile or an adjacent geographic tile from the change leader. In some aspects, the request is signed by a certificate and includes an asymmetric encryption key and an identifier for the new key being requested. The change leader is configured to authenticate the request and, based on the authentication, generate a response to the request including the new key that is encrypted with the provided asymmetric encryption key.

In some aspects, a mechanism is configured to manage requests so that the channel is not flooded and the change leader has sufficient time to process and authenticate requests. For example, the change leader may also indicate time slots for other peer wireless devices to request the new key between the first and the second deadlines. In some cases, the mechanism may randomly select a time at or before some deadline or an ordering may be determined based on public properties of the devices (e.g., MAC addresses, proximity to the center of the geographic region, contents of the Message Authentication Code attached to the last message, a temporary ID if all senders are using one, etc.). In some cases, selection of the change leader may also be based on hardware capacity for encryption operations.

In some aspects, at the first deadline t_{change}, authorized wireless devices start to attach a first MAC associated with the old key and a second MAC associated with the new key. For example, if a wireless device is unaware of the key rotation, receiving a message with the first MAC and the second MAC indicates that it missed the key rotation and can request the updated key. At the second time t_{drop}, authorized wireless devices transmit application messages with a single MAC associated with the new key. In some aspects, an application message includes a communication generated by an application-layer process of a wireless device to convey operational, user, and/or system data.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, road side units (RSUs), and/or other devices depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

A radio frequency signal or “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

In some aspects, V2X communications are protected to prevent malicious actors from adversely affecting the system. For example, malicious actors can adversely affect traffic and increase congestion, cause autonomous collisions, cause phantom vehicles to be present in the network to affect traffic, interfere with vehicle safety and increase safety risks, grant unauthorized safety to vehicle systems, and so forth. Strong cryptography is necessary to protect V2X communication to ensure that autonomous systems work safely, reduce congestion, and provide efficient usage of traffic infrastructure.

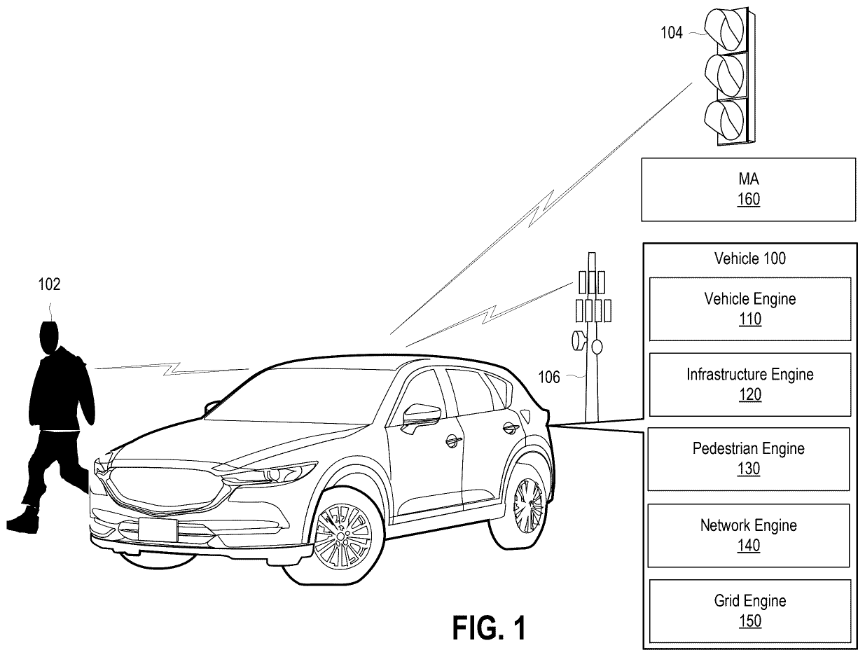

FIG. 1 is a diagram of a vehicle 100 and various V2X functions of the vehicle in accordance with some aspects of the disclosure. In some aspects, the vehicle is configured to form an ad-hoc network with different endpoints for safety, payment, and other functions. For example, a V2X network of the vehicle can communicate with a pedestrian 102, traffic infrastructure 104, networks such as wireless communication network 106, and so forth.

A vehicle may include a vehicle communication engine 110. The vehicle communication engine 110 is configured to interact with other vehicles using vehicle-to-vehicle (V2V) functions to enhance safety and traffic management. Non-limiting examples of V2V functions include collision avoidance (e.g., alerts vehicles about potential collisions such as blind spots, intersection risks, etc.), emergency brake warning (e.g., notifications following vehicles when a vehicle suddenly brakes), lane change assistance (e.g., a notification to warn drivers when changing lanes if another vehicle is in the blind spot), adaptive cruise control coordination, platooning support (e.g., to enable autonomous coordination of vehicles traveling in close formation or a platoon), overtaking assistance (e.g., passing), intersection movement assistance (e.g., at intersections by sharing vehicle trajectories).

In another aspect, a vehicle can also include infrastructure engine 120 for vehicle-to-infrastructure (V2I) functions. The infrastructure engine 120 is configured to interact with roadside infrastructure for better traffic management and efficiency, such as the traffic infrastructure 104 (e.g., a traffic light, an electronic toll device, parking payment, and so forth). Non-limiting examples of V2I functions include traffic signal priority requests (e.g., enabling emergency and public transport vehicles to preempt traffic signals), red light violation warnings (e.g., an alert of risk of running a red light), dynamic speed limit adjustment (e.g., based on traffic and/or weather conditions), smart traffic light coordination (e.g., to optimize traffic timing based on real-time congestion data), electronic toll collection (e.g., electronic toll payments), road hazard warnings, parking space detection, and railroad crossing alerts.

In another aspect, a vehicle can also include pedestrian engine 130 for vehicle-to-pedestrian (V2P) functions to enhance pedestrian safety by enabling communication between vehicles and vulnerable road users, such as a pedestrian 102. Non-limiting examples of V2P functions include pedestrian collision warnings, bicycle proximity warnings, crosswalk alerts, mobile device alerts for pedestrians, and school zone alerts.

In another aspect, a vehicle can also include network engine 140 for vehicle-to-network (V2N) functions to integrate with cloud services, traffic systems, and other connected devices. Non-limiting examples of V2N functions include traffic congestion updates, weather hazard warnings, remote software updates (e.g., over-the-air software and firmware updates), cloud-based navigation assistance, emergency services notification, and vehicle theft tracking. In some aspects, network engine 140 communicates via the wireless communication network 106.

In another aspect, a vehicle can also include a grid engine 150 for vehicle-to-grid (V2G) functions to enable interaction with power grids, supporting energy efficiency and other sustainability options. Non-limiting examples of V2G functions include smart charging coordination (e.g., vehicles adjust charging schedules based on grid demand), bidirectional energy transfer (e.g., vehicles can supply power back to the grid during peak demand), renewable energy integration, and battery health monitoring.

In some aspects, V2X is an ad hoc local wireless network that can rapidly change based on objects moving in and out of a local area or may change more slowly based on objects moving at a similar rate. V2X devices are configured to adapt to these changes rapidly and include different types of messages for different purposes. In some aspects, there are a variety of different messages that the vehicle 100 may implement. One example is a BSM message that identifies vehicle state and behavior. BSM is a core safety message in V2V communication to share real-time vehicle status (e.g., vehicle position, speed, heading, acceleration, brake status, turn signals, etc.). The BSM is broadcast approximately 10 times per second to adjacent devices. Other types of messages include a signal phase and timing (SPaT) signal that provides traffic light information and roadside unit (RSU) message for communicating current and future traffic signals.

V2X signals enable real-time communication between vehicles, infrastructure, pedestrians, and networks to improve road safety, traffic efficiency, and autonomous driving and control significant aspects of transportation. V2X signals are a prime target for cyber threats like spoofing (e.g., to control traffic lights) and eavesdropping. Cryptography ensures the integrity, authenticity, and confidentiality of V2X messages and prevents malicious actors from injecting false data, intercepting sensitive information, maliciously controlling infrastructure, or cheating payment systems (e.g., ETC). Given the real-time constraints of V2X communication, cryptographic solutions should be both lightweight and highly secure, balancing performance with resilience against emerging threats, including future quantum attacks.

In some aspects, quantum computers can break classical cryptography (e.g., hard problems in number theory such as integer factorization, discrete logarithms, and elliptic curve cryptography) by efficiently solving problems that are computationally infeasible for classical computers using Shor's algorithm. For example, quantum computers can break widely used cryptographic schemes like RSA and ECC in polynomial time and render classical cryptography schemes insecure once large-scale quantum computers become available. However, quantum computers will not be publicly available in the foreseeable future due to their cost, complexity, and national security implications. Governments and major research institutions will likely maintain strict control over such technology, limiting access to a few highly regulated entities. Classical cryptographic schemes will continue to be practical for applications like V2X communication. Since V2X networks operate in an open and dynamic environment, mass deployment of quantum-resistant cryptography is challenging, and current classical cryptographic methods provide a balance of security and performance that remains viable as long as quantum computing remains inaccessible to the general public.

In addition, post-quantum cryptography (PQC) introduces a significant challenge for V2X communication due to the large key and signature sizes of quantum-resistant algorithms. V2X systems operate in highly dynamic environments with strict latency and bandwidth constraints since vehicles exchange safety-critical messages in real-time. Many PQC algorithms, such as lattice-based and code-based schemes, use much larger key sizes as compared to classical cryptographic methods and are computationally expensive. In addition, the larger keys associated with PQC cryptography increase the amount of data that must be transmitted over wireless channels and the added overhead can lead to network congestion, increased transmission latency, and reduced reliability.

In some aspects, the V2X system may include a misbehavior authority (MA) 160. The MA 160 detects, analyzes, and responds to security threats such as malicious actors, faulty vehicles, or compromised cryptographic credentials. The MA collects misbehavior reports from vehicles (e.g., the vehicle 100) and roadside units, which flag suspicious activities like replay attacks, message injection, false safety alerts, or inconsistent positioning data. The MA 160 may verify these reports using cryptographic evidence, such as invalid TESLA MACs, revoked certificates, or repeated message discrepancies, to determine whether a vehicle or entity is engaging in malicious behavior. If misbehavior is confirmed, the MA 160 can revoke certificates, add the offender to a blacklist, or trigger an OTA update to mitigate the threat. Without an MA 160, V2X networks would be vulnerable to persistent attacks, as vehicles alone lack the authority to enforce penalties or prevent malicious actors from rejoining the system. The MA 160 ensures that V2X communications remain trustworthy, secure, and resistant to both accidental and intentional disruptions, maintaining the integrity of critical safety applications.

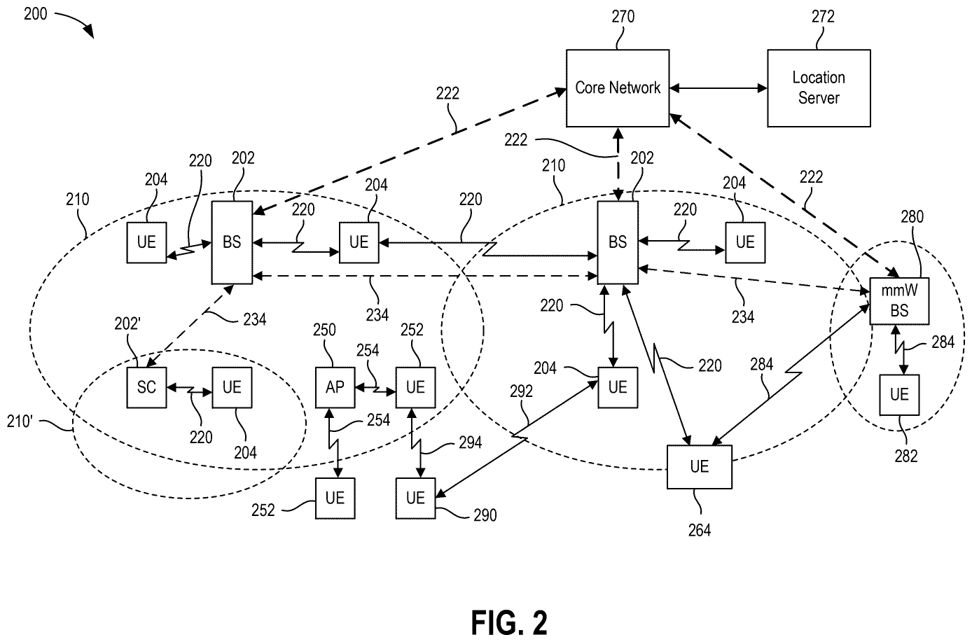

According to various aspects, FIG. 2 illustrates an example wireless communications system 200. The wireless communications system 200 (which may also be referred to as a wireless wide area network (WWAN)) can include various base stations 202 and various UEs 204. In some aspects, the base stations 202 may also be referred to as “network entities” or “network nodes.” One or more of the base stations 202 can be implemented in an aggregated or monolithic base station architecture. Additionally or alternatively, one or more of the base stations 202 can be implemented in a disaggregated base station architecture and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 202 can include macro cell base stations (high power cellular base stations) and/or small cell base stations (low power cellular base stations). In an aspect, the macro cell base station may include eNBs and/or ng-eNBs where the wireless communications system 200 corresponds to a long-term evolution (LTE) network, or gNBs where the wireless communications system 200 corresponds to an NR network, or a combination of both, and the small cell base stations may include femtocells, picocells, microcells, etc.

The base stations 202 may collectively form a RAN and interface with a core network 270 (e.g., an evolved packet core (EPC) or a 5G core (5GC)) through backhaul links 222, and through the core network 270 to one or more location servers 272 (which may be part of the core network 270 or may be external to core network 270). In addition to other functions, the base stations 202 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 202 may communicate with each other directly or indirectly (e.g., through the EPC or 5GC) over backhaul links 234, which may be wired and/or wireless.

The base stations 202 may wirelessly communicate with the UEs 204. Each of the base stations 202 may provide communication coverage for a respective geographic coverage area 210. In an aspect, one or more cells may be supported by a base station 202 in each coverage area 210. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage area 210.

While neighboring macro cell base station 202 geographic coverage area 210 may partially overlap (e.g., in a handover region), some of the geographic coverage areas 210 may be substantially overlapped by a larger geographic coverage area 210. For example, a small cell base station 202′ may have a coverage area 210′ that substantially overlaps with the coverage area 210 of one or more macro cell base stations 202. A network that includes both small cell and macro cell base stations may be known as a heterogeneous network. A heterogeneous network may also include home eNBs (HeNBs), which may provide service to a restricted group known as a closed subscriber group (CSG).

The communication links 220 between the base stations 202 and the UEs 204 may include uplink (also referred to as reverse link) transmissions from a UE 204 to a base station 202 and/or downlink (also referred to as forward link) transmissions from a base station 202 to a UE 204. The communication links 220 may use MIMO antenna technology, including spatial multiplexing, beamforming, and/or transmit diversity. The communication links 220 may be through one or more carrier frequencies. Allocation of carriers may be asymmetric with respect to downlink and uplink (e.g., more or less carriers may be allocated for downlink than for uplink).

The wireless communications system 200 may further include a WLAN AP 250 in communication with WLAN stations (STAs) 252 via communication links 254 in an unlicensed frequency spectrum (e.g., 5 gigahertz (GHz)). When communicating in an unlicensed frequency spectrum, the WLAN STAs 252 and/or the WLAN AP 250 may perform a clear channel assessment (CCA) or listen before talk (LBT) procedure prior to communicating in order to determine whether the channel is available. In some examples, the wireless communications system 200 can include devices (e.g., UEs, etc.) that communicate with one or more UEs 204, base stations 202, APs 250, etc. utilizing the ultra-wideband (UWB) spectrum. The UWB spectrum can range from 3.1 to 10.5 GHz.

The small cell base station 202′ may operate in a licensed and/or an unlicensed frequency spectrum. When operating in an unlicensed frequency spectrum, the small cell base station 202′ may employ LTE or NR technology and use the same 5 GHz unlicensed frequency spectrum as used by the WLAN AP 250. The small cell base station 202′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 200 may further include a millimeter wave (mmW) base station 280 that may operate in mmW frequencies and/or near mmW frequencies in communication with a UE 282. The mmW base station 280 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 200 millimeters. The super high frequency (SHF) band extends between 3 GHz and 30 GHz, also referred to as centimeter wave. Communications using the mmW and/or near mmW radio frequency band have high path loss and a relatively short range. The mmW base station 280 and the UE 282 may utilize beamforming (transmit and/or receive) over an mmW communication link 284 to compensate for the extremely high path loss and short range. Further, it will be appreciated that in alternative configurations, one or more base stations 202 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 202/280, UEs 204/282) operate is divided into multiple frequency ranges, FR1 (from 450 to 6000 megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 204/282 and the cell in which the UE 204/282 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 204 and the anchor carrier and that may be used to provide additional radio resources. In some cases, the secondary carrier may be a carrier in an unlicensed frequency. The secondary carrier may contain necessary signaling information and signals, for example, those that are UE-specific may not be present in the secondary carrier, since the primary uplink and downlink carriers are typically UE-specific. This means that different UEs 204/282 in a cell may have different downlink primary carriers. The same is true for the uplink primary carriers. The network is able to change the primary carrier of any UE 204/282 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 2, one of the frequencies utilized by the macro cell base stations 202 may be an anchor carrier (or “PCell”) and other frequencies utilized by the macro cell base stations 202 and/or the mmW base station 280 may be secondary carriers (“SCells”). In carrier aggregation, the base stations 202 and/or the UEs 204 may use spectrum up to Y MHz (e.g., 5, 10, 15, 20, 200 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 204/282 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 202 and/or a UE 204 is equipped with multiple receivers and/or transmitters. For example, a UE 204 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver that is tuneable to band ‘Z’ only. In this example, if the UE 204 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 204 is being served in band ‘X’ or band ‘Y,’ because of the separate “Receiver 2,” the UE 204 can measure band ‘Z’without interrupting the service on band ‘X’or band ‘Y.’

The wireless communications system 200 may further include a UE 264 that may communicate with a macro cell base station 202 over a communication link 220 and/or the mmW base station 280 over an mmW communication link 284. For example, the macro cell base station 202 may support a PCell and one or more SCells for the UE 264 and the mmW base station 280 may support one or more SCells for the UE 264.

The wireless communications system 200 may further include one or more UEs, such as UE 290, that connects indirectly to one or more communication networks via one or more device-to-device (D2D) peer-to-peer (P2P) links (referred to as “sidelinks”). In the example of FIG. 2, UE 290 has a D2D P2P link 292 with one of the UEs 204 connected to one of the base stations 202 (e.g., through which UE 290 may indirectly obtain cellular connectivity) and a D2D P2P link 294 with WLAN STA 252 connected to the WLAN AP 250 (through which UE 290 may indirectly obtain WLAN-based Internet connectivity). In an example, the D2D P2P links 292 and 294 may be supported with any well-known D2D RAT, such as LTE Direct (LTE-D), Wi-Fi Direct (Wi-Fi-D), Bluetooth®, and so on.

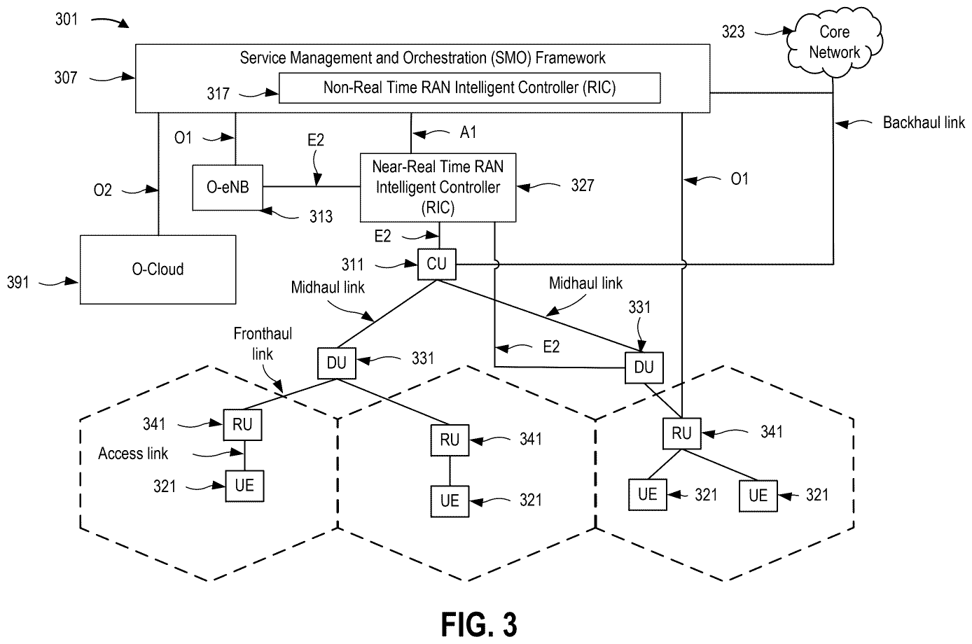

FIG. 3 is a diagram illustrating an example of a disaggregated base station architecture, which may be employed by the disclosed system for event-based network and blockchain formation, in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 3 shows a diagram illustrating an example disaggregated base station 301 architecture. The disaggregated base station 301 architecture may include one or more central units (CUs) 311 that can communicate directly with a core network 323 via a backhaul link, or indirectly with the core network 323 through one or more disaggregated base station units (such as a Near-Real Time (Near-RT) RAN Intelligent Controller (RIC) 327 via an E2 link, or a Non-Real Time (Non-RT) RIC 317 associated with a Service Management and Orchestration (SMO) Framework 307, or both). A CU 311 may communicate with one or more distributed units (DUs) 331 via respective midhaul links, such as an F1 interface. The DUs 331 may communicate with one or more radio units (RUs) 341 via respective fronthaul links. The RUs 341 may communicate with respective UEs 321 via one or more RF access links. In some implementations, the UE 321 may be simultaneously served by multiple RUs 341.

Each of the units, i.e., the CUs 311, the DUs 331, the RUs 341, as well as the Near-RT RICs 327, the Non-RT RICs 317 and the SMO Framework 307, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 311 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 311. The CU 311 may be configured to handle user plane functionality (i.e., Central Unit-User Plane (CU-UP)), control plane functionality (i.e., Central Unit-Control Plane (CU-CP)), or a combination thereof. In some implementations, the CU 311 can be logically split into one or more CU-UP units and one or more CU-CP units. The CU-UP unit can communicate bidirectionally with the CU-CP unit via an interface, such as the E1 interface when implemented in an O-RAN configuration. The CU 311 can be implemented to communicate with the DU 331, as necessary, for network control and signaling.

The DU 331 may correspond to a logical unit that includes one or more base station functions to control the operation of one or more RUs 341. In some aspects, the DU 331 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 331 may further host one or more low PHY layers. Each layer (or module) can be implemented with an interface configured to communicate signals with other layers (and modules) hosted by the DU 331, or with the control functions hosted by the CU 311.

Lower-layer functionality can be implemented by one or more RUs 341. In some deployments, an RU 341, controlled by a DU 331, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 341 can be implemented to handle over the air (OTA) communication with one or more UEs 321. In some implementations, real-time and non-real-time aspects of control and user plane communication with the RU(s) 341 can be controlled by the corresponding DU 331. In some scenarios, this configuration can enable the DU(s) 331 and the CU 311 to be implemented in a cloud-based RAN architecture, such as a vRAN architecture.

The SMO Framework 307 may be configured to support RAN deployment and provisioning of non-virtualized and virtualized network elements. For non-virtualized network elements, the SMO Framework 307 may be configured to support the deployment of dedicated physical resources for RAN coverage requirements which may be managed via an operations and maintenance interface (such as an O1 interface). For virtualized network elements, the SMO Framework 307 may be configured to interact with a cloud computing platform (such as an open cloud (O-Cloud) 391) to perform network element life cycle management (such as to instantiate virtualized network elements) via a cloud computing platform interface (such as an O2 interface). Such virtualized network elements can include, but are not limited to, CUs 311, DUs 331, RUs 341, and Near-RT RICs 327. In some implementations, the SMO Framework 307 can communicate with a hardware aspect of a 4G RAN, such as an open eNB (O-eNB) 313, via an O1 interface. Additionally, in some implementations, the SMO Framework 307 can communicate directly with one or more RUs 341 via an O1 interface. The SMO Framework 307 also may include a Non-RT RIC 317 configured to support functionality of the SMO Framework 307.

The Non-RT RIC 317 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 327. The Non-RT RIC 317 may be coupled to or communicate with (such as via an A1 interface) the Near-RT RIC 327. The Near-RT RIC 327 may be configured to include a logical function that enables near-real-time control and optimization of RAN elements and resources via data collection and actions over an interface (such as via an E2 interface) connecting one or more CUs 311, one or more DUs 331, or both, as well as an O-eNB 313, with the Near-RT RIC 327.

In some implementations, to generate AI/ML models to be deployed in the Near-RT RIC 327, the Non-RT RIC 317 may receive parameters or external enrichment information from external servers. Such information may be utilized by the Near-RT RIC 327 and may be received at the SMO Framework 307 or the Non-RT RIC 317 from non-network data sources or from network functions. In some examples, the Non-RT RIC 317 or the Near-RT RIC 327 may be configured to tune RAN behavior or performance. For example, the Non-RT RIC 317 may monitor long-term trends and patterns for performance and employ AI/ML models to perform corrective actions through the SMO Framework 307 (such as reconfiguration via O1) or via creation of RAN management policies (such as A1 policies).

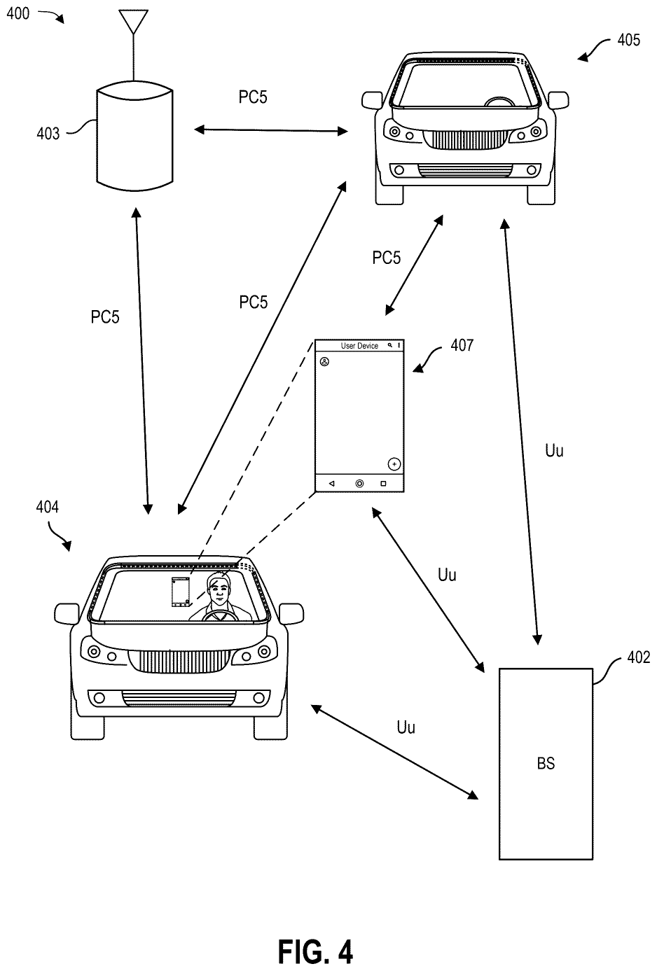

FIG. 4 illustrates examples of different communication mechanisms 400 used by various UEs. In one example of sidelink communications, FIG. 4 illustrates a vehicle 404, a vehicle 405, and an RSU 403 communicating with each other using PC5, DSRC, or other device-to-device direct signaling interfaces. In addition, the vehicle 404 and the vehicle 405 may communicate with a base station (BS) 402 using a network (Uu) interface. The BS 402 can include a gNB in some examples. FIG. 4 also illustrates a user device 407 communicating with the BS 402 using a network (Uu) interface. As described below, functionalities can be transferred from a vehicle (e.g., vehicle 404) to a user device (e.g., user device 407) based on one or more characteristics or factors (e.g., temperature, humidity, etc.). In one illustrative example, V2X functionality can be transitioned from the vehicle 404 to the user device 407, after which the user device 407 can communicate with other vehicles (e.g., vehicle 405) over a PC5 interface (or other device-to-device direct interface, such as a DSRC interface), as shown in FIG. 4.

While FIG. 4 illustrates a particular number of vehicles (e.g., two vehicles 404 and 405) communicating with each other and/or with RSU 403, BS 402, and/or user device 407, the present disclosure is not limited thereto. For instance, tens or hundreds of such vehicles may be communicating with one another and/or with RSU 403, BS 402, and/or user device 407. At any given point in time, each such vehicle, RSU 403, BS 402, and/or user device 407 may transmit various types of information as messages to other nearby vehicles resulting in each vehicle (e.g., vehicles 404 and/or 405), RSU 403, BS 402, and/or user device 407 receiving hundreds or thousands of messages from other nearby vehicles, RSUs, base stations, and/or other UEs per second.

While PC5 interfaces are shown in FIG. 4, the various UEs (e.g., vehicles, user devices, etc.) and RSU(s) can communicate directly using any suitable type of direct interface, such as an 802.11 DSRC interface, a Bluetooth™ interface, and/or other interface. For example, a vehicle can communicate with a user device over a direct communications interface (e.g., using PC5 and/or DSRC), a vehicle can communicate with another vehicle over the direct communications interface, a user device can communicate with another user device over the direct communications interface, a UE (e.g., a vehicle, user device, etc.) can communicate with an RSU over the direct communications interface, an RSU can communicate with another RSU over the direct communications interface, and the like.

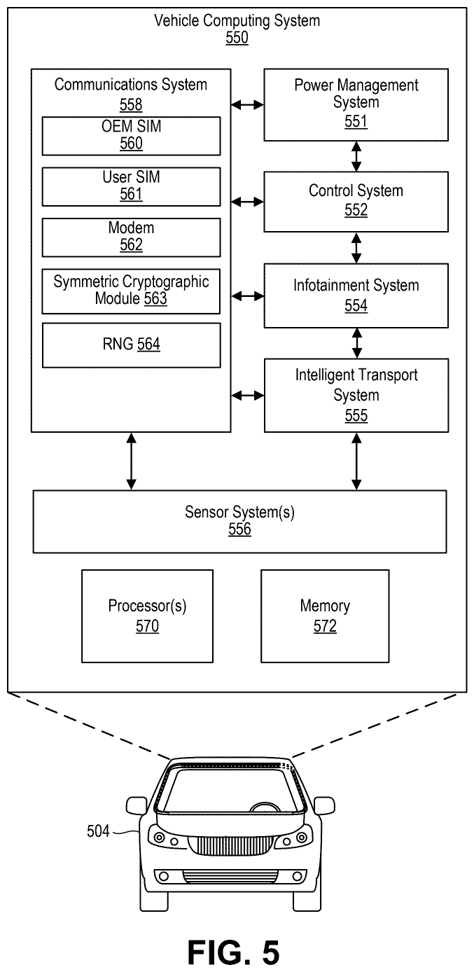

FIG. 5 is a block diagram illustrating an example of a vehicle computing system 550 of a vehicle 504. The vehicle 504 is an example of a UE that can communicate with a network (e.g., an eNB, a gNB, a positioning beacon, a location measurement unit, and/or other network entity) over a Uu interface and with other UEs using V2X communications over a PC5 interface, a C-V2X interface, or other device-to-device direct interface, such as a DSRC interface). As shown, the vehicle computing system 550 can include at least a power management system 551, a control system 552, an infotainment system 554, an intelligent transport system (ITS) 555, one or more sensor systems 556, and a communications system 558. In some cases, the vehicle computing system 550 can include or can be implemented using any type of processor 570 or system on chip, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system. The vehicle computing system 550 may also include a memory 572 for storing instructions, data, and so forth.

The control system 552 can be configured to control one or more operations of the vehicle 504, the power management system 551, the computing system 550, the infotainment system 554, the ITS 555, and/or one or more other systems of the vehicle 504 (e.g., a braking system, a steering system, a safety system other than the ITS 555, a cabin system, and/or other system). In some examples, the control system 552 can include one or more electronic control units (ECUs). An ECU can control one or more of the electrical systems or subsystems in a vehicle. Examples of specific ECUs that can be included as part of the control system 552 include an engine control module (ECM), a powertrain control module (PCM), a transmission control module (TCM), a brake control module (BCM), a central control module (CCM), a central timing module (CTM), among others. In some cases, the control system 552 can receive sensor signals from the one or more sensor systems 556 and can communicate with other systems of the vehicle computing system 550 to operate the vehicle 504.

The vehicle computing system 550 also includes a power management system 551. In some implementations, the power management system 551 can include a power management integrated circuit (PMIC), a standby battery, and/or other components. In some cases, other systems of the vehicle computing system 550 can include one or more PMICs, batteries, and/or other components. The power management system 551 can perform power management functions for the vehicle 504, such as managing a power supply for the computing system 550 and/or other parts of the vehicle. For example, the power management system 551 can provide a stable power supply in view of power fluctuations, such as based on starting an engine of the vehicle. In another example, the power management system 551 can perform thermal monitoring operations, such as by checking ambient and/or transistor junction temperatures. In another example, the power management system 551 can perform certain functions based on detecting a certain temperature level, such as causing a cooling system (e.g., one or more fans, an air conditioning system, etc.) to cool certain components of the vehicle computing system 550 (e.g., the control system 552, such as one or more ECUs), shutting down certain functionalities of the vehicle computing system 550 (e.g., limiting the infotainment system 554, such as by shutting off one or more displays, disconnecting from a wireless network, etc.), among other functions.

The vehicle computing system 550 further includes a communications system 558. The communications system 558 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 558 is configured to transmit and receive information wirelessly over any suitable wireless network (e.g., a 3G network, 4G network, 5G network, WiFi network, Bluetooth™ network, and/or other network). The communications system 558 includes various components or devices used to perform the wireless communication functionalities, including an original equipment manufacturer (OEM) subscriber identity module (referred to as a SIM or SIM card) 560, a user SIM 561, and a modem 562. While the vehicle computing system 550 is shown as having two SIMs and one modem, the computing system 550 can have any number of SIMs (e.g., one SIM or more than two SIMs) and any number of modems (e.g., one modem, two modems, or more than two modems) in some implementations. The vehicle computing system 550 may also include a random number generator (RNG) 564 for capturing entropy and generating various types of random numbers.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 560 can be used by the communications system 558 for establishing a wireless connection for vehicle-based operations, such as for conducting emergency-calling (eCall) functions, communicating with a communications system of the vehicle manufacturer (e.g., for software updates, etc.), among other operations. The OEM SIM 560 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 561 can be used by the communications system 558 for performing wireless network access functions in order to support a user data connection (e.g., for conducting phone calls, messaging, infotainment related services, among others). In some cases, a user device of a user can connect with the vehicle computing system 550 over an interface (e.g., over PC5, Bluetooth™, WiFI™ (e.g., DSRC), a universal serial bus (USB) port, and/or other wireless or wired interface). Once connected, the user device can transfer wireless network access functionality from the user device to the communications system 558 of the vehicle, in which case the user device can cease performance of the wireless network access functionality (e.g., during the period in which the communications system 558 is performing the wireless access functionality). The communications system 558 can begin interacting with a base station to perform one or more wireless communication operations, such as facilitating a phone call, transmitting and/or receiving data (e.g., messaging, video, audio, etc.), among other operations. In such cases, other components of the vehicle computing system 550 can be used to output data received by the communications system 558. For example, the infotainment system 554 (described below) can display video received by the communications system 558 on one or more displays and/or can output audio received by the communications system 558 using one or more speakers.

A modem is a device that modulates one or more carrier wave signals to encode digital information for transmission, and demodulates signals to decode the transmitted information. The modem 562 (and/or one or more other modems of the communications system 558) can be used for communication of data for the OEM SIM 560 and/or the user SIM 561. In some examples, the modem 562 can include a 4G (or LTE) modem and another modem (not shown) of the communications system 558 can include a 5G (or NR) modem. In some examples, the communications system 558 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 562 (and/or one or more other modems of the communications system 558) can be used for performing V2X communications (e.g., with other vehicles for V2V communications, with other devices for D2D communications, with infrastructure systems for V2I communications, with pedestrian UEs for V2P communications, etc.). In some examples, the communications system 558 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some aspects, the communications system 558 may include a symmetric cryptographic module 563 configured to protect content using various symmetric cryptographic algorithms. For example, the symmetrical cryptographic module 563 may support AES, data encryption standard (DES), Blowfish, etc. In addition, the symmetrical cryptographic module 563 may support time-delay release of keys to implement asymmetric time cryptographic techniques such as TESLA.

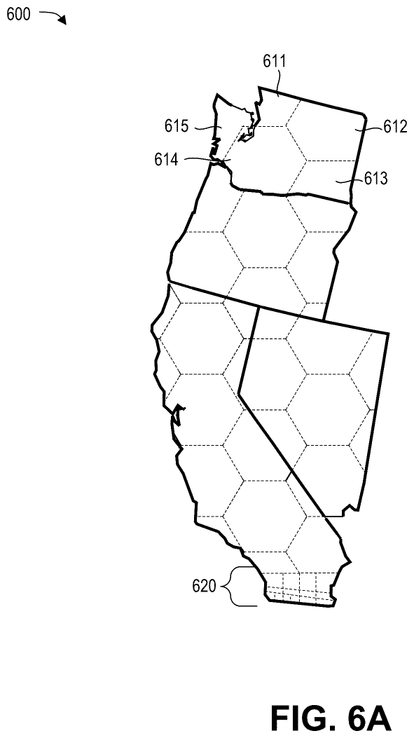

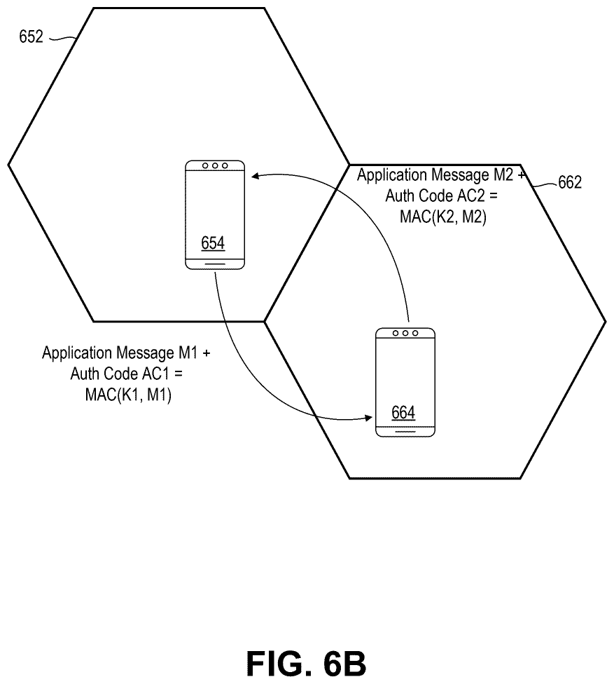

FIG. 6A is an illustration of geographical tiles of a partial portion of a map 600 in accordance with some aspects of the disclosure. For example, FIG. 6A illustrates western states including northern and southern borders. In some aspect, each geographical area is distinct (e.g., does not overlap with another geographical area) and can be divided in various ways. In some aspects, regions can be smaller or larger based on density, traffic density, traffic patterns, and other factors.

Each geographic tile is associated with a distinct identifier. For example, a distinct identifier may be a geographical center of tile such as a tuple of [latitude, longitude] or other representation of the geographical location. In some aspects, using a center of a geographic tile could cause issues when infrastructure nodes are not available, such as when a symmetric key update period occurs and a peer-to-peer key update occurs (e.g., without a central key service). For example, in some cases when a peer-to-peer key update occurs, a wireless device is selected based on a collective function such as distance to the center of the geographical tile. Other types of functions can be used, such as a non-deterministic function (e.g., a hash) and so forth.

In some aspects, the geographic tiles can be ordered based on geographical features or a pattern, and so forth. For example, a jurisdiction (e.g., Washington state) may include identifiers that are labeled in a counter-clockwise direction starting at a most northern position of geographical regions 611, 612, 613, 614, and 615.

As shown in FIG. 6A, geographical tiles can have different sizes and shapes, and sizes may be representative of population density, traffic density and other features. In some cases, the geographical tiles may become smaller at jurisdictional boundaries, such as in the region 620 along the southern border. For example, at jurisdictional boundaries, different commercial services may operate due to regulatory licensing, which may affect how geographical tiles are configured.

FIG. 6B illustrates an example communication scenario for geographically diverse symmetric authentication between wireless devices in accordance with some aspects of the disclosure. In the illustrated example, a first geographic tile 652 includes a first wireless device 654, and a second geographic tile 662 includes a second wireless device 664. As shown in FIG. 6B, the first geographic tile 652 and the second geographic tile 662 represent distinct geographic areas.

The first geographic tile 652 generally represents a geographic region associated with a first group key. In some aspects, the first group key is a symmetric key shared among authorized wireless devices operating within, or authorized for communications associated with, the first geographic tile 652. In the illustrated example, the first wireless device 654 is located within the first geographic tile 652 and is configured to access, store, and use the first group key for generating authentication information for outbound application-layer communications.

The second geographic tile 662 represents a geographic region associated with a second group key. In some aspects, the second group key is a symmetric key shared among authorized wireless devices operating within, or authorized for communications associated with, the second geographic tile 662. In the illustrated example, the second wireless device 664 is located within the second geographic tile 662 and is configured to access, store, and use the second group key for generating authentication information for outbound application-layer communications.

The first wireless device 654 is configured to transmit a first application message M1 together with a first authentication code AC1. In some aspects, the first authentication code AC1 is generated by applying a cryptographic authentication operation to the first application message M1 using the first group key K1 (e.g., AC1=MAC(K1, M1)), where K1 denotes the first group key. In some aspects, the first application message M1 can include a V2X safety message, a cooperative perception message, a traffic advisory, a telemetry message, or another application payload. In some aspects, the first authentication code AC1 can be generated using other techniques, including but not limited to, generating an authentication tag using an authenticated encryption algorithm based on the first group key and the first application message as inputs, generating a digital signature or keyed hash value derived from the first group key and the first application message, and/or otherwise producing a cryptographic authentication value based on application of the first group key to the first application message.

In the illustrated exchange, the first application message M1 and the first authentication code AC1 are transmitted from the first wireless device 654 toward the second wireless device 664. In some aspects, the first wireless device 654 transmits the first application message M1 and the first authentication code AC1 while the first wireless device 654 remains in the first geographic tile 652.

The second geographic tile 662 illustrates receipt and handling of the first application message M1 and the first authentication code AC1 by the second wireless device 664. In some aspects, the second wireless device 664 is configured to verify the first authentication code AC1 using one or more keys available to the second wireless device 664, including, for example, a key corresponding to the first geographic tile 652 when the second wireless device 664 is provisioned with adjacent-tile keys to support cross-tile communications. In some aspects, the verification operation is performed prior to acting on the application payload to reduce susceptibility to unauthorized message injection.

FIG. 6B also depicts the second wireless device 664 transmitting a second application message M2 together with a second authentication code AC2. In some aspects, the second authentication code AC2 is generated by applying a message authentication code function to the second application message M2 using the second group key associated with the second geographic tile 662 (e.g., AC2=MAC(K2, M2)), where K2 denotes the second group key. In some aspects, the second application message M2 can include a response, acknowledgment, or application-layer data intended for use by the first wireless device 654.

The first wireless device 654 receives the second application message M2 and the second authentication code AC2 from the second wireless device 664. In some aspects, the first wireless device 654 receives the second application message M2 and the second authentication code AC2 while the first wireless device 654 remains within the first geographic tile 652, even though the transmitting second wireless device 664 is located in the second geographic tile 662.

In some aspects, the first wireless device 654 is configured to validate, and in some cases decrypt or otherwise authenticate, the received second application message M2 based on the second group key associated with the second geographic tile 662. For example, the first wireless device 654 can compute an expected message authentication code over the second application message M2 using K2 and compare the computed value to the received second authentication code AC2 to determine whether the second application message M2 is authenticated. In some aspects, the first wireless device 654 obtains and stores the second group key (e.g., via a key service or via peer-to-peer key distribution), which enables the first wireless device 654 to validate messages originating from the second geographic tile 662 while the first wireless device 654 is located in the first geographic tile 652.

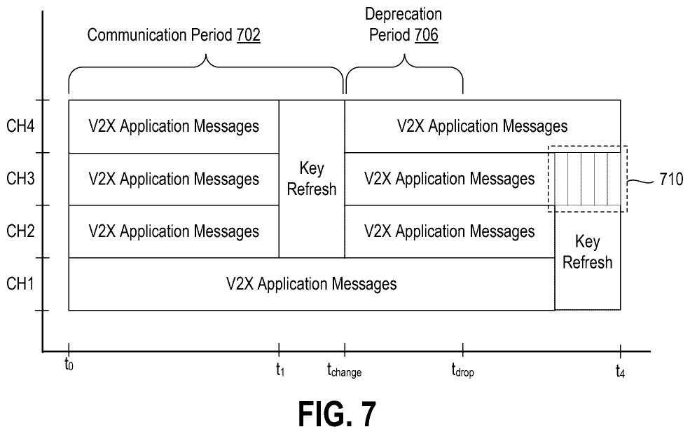

FIG. 7 is a timeline illustrating a key rotation and a different period associated with a first key. For example, a first key associated with time t₀ is used during the communication period 702. At time t₁, a wireless device or a key service initiates a key rotation within a geographic area and a change leader is identified that generates a second key. Between time t₁ and t_{change}, the wireless devices and the change leader update and exchange symmetric keys that are used in a next period. After time t_{change}, during the deprecation period 706, application messages exchanged in the geographic area include a first MAC signed by the first key and the second MAC signed by the second key. At time t_{drop}, application messages exchanged in the geographic area include a MAC signed by the second key. In some cases, this allows a device to identify that it is using an old key while new keys are allocated during period 710.

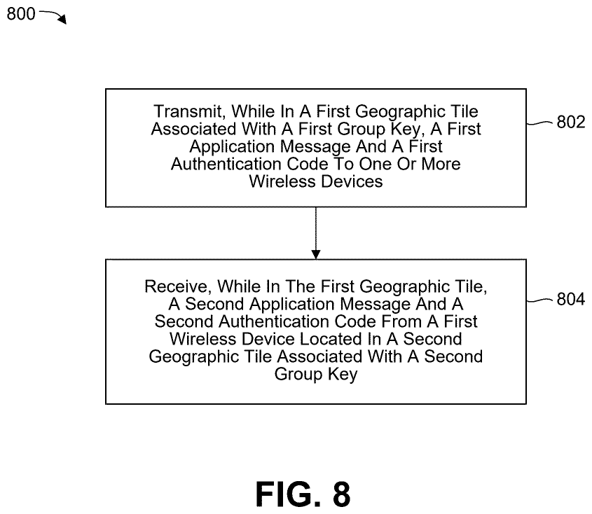

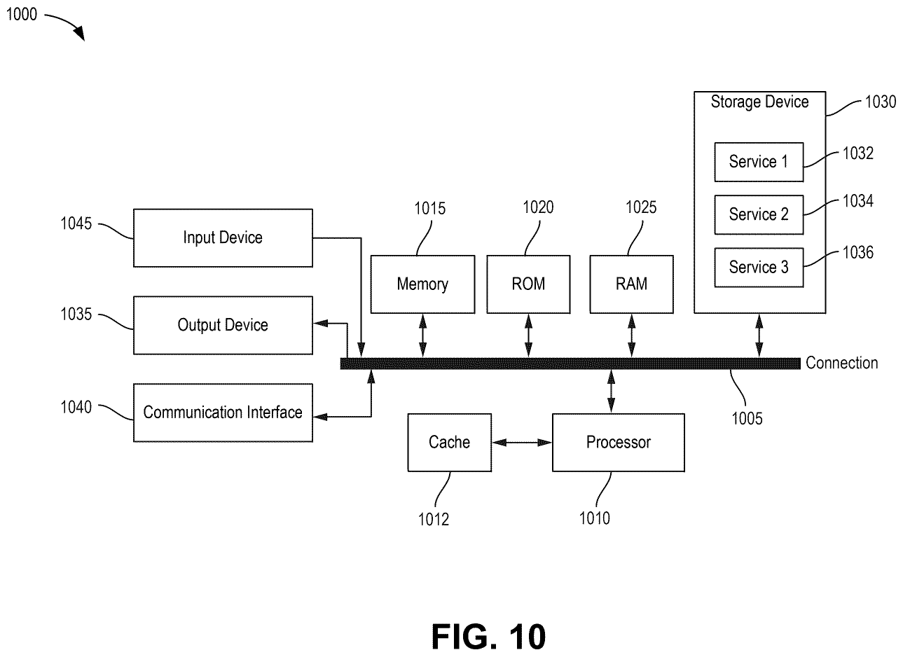

FIG. 8 is a flow diagram illustrating a process for protecting information using cryptographic functions, such as in a communications network (e.g., a V2X communication network) in accordance with some aspects of the disclosure. The process 800 can be performed by a hardware device (or apparatus) or a component (e.g., one or more chipsets, a system-on-chip (SoC) of one or more processors or modules such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., a machine learning (ML) system such as a neural network model, any combination thereof, and/or other component or system) of the computing device. The operations of the process 800 may be implemented as hardware components that are executed based on software instructions run on one or more processors (e.g., CPU, GPU, DSP, NPU or neural engine, SoC, the processor 1010 of FIG. 10, and/or other processor(s)).

At block 802, the computing device may transmit, while in a first geographic tile associated with a first group key, a first application message and a first authentication code to one or more wireless devices. In one aspect, the first authentication code is generated based on application of the first group key to the first application message.

In some aspects, the computing device may receive, while in the first geographic tile, the second group key. The second group key is encrypted using a public key associated with an asymmetric encryption. For example, the computing device can receive the second group key when it enters the first geographic tile. The computing device may then receive, while in the first geographic tile, a second application message associated with a wireless device in the second geographic tile, and decrypt the second application message or validate the second application message based on the second group key. In some cases, the asymmetric encryption can be based on classical encryption. In other cases, the asymmetric encryption can be based on PQC encryption (e.g., when quantum computers are more available).

In some aspects, the memory is configured to store group keys associated with each geographic tile that borders the first geographic tile. The keys may be in a key-value pair, with the value being the encryption key and the key identifying a geographical feature (e.g., map<geolocation, key>;).

At block 804, the computing device may receive, while in the first geographic tile, a second application message and a second authentication code from a first wireless device located in a second geographic tile associated with a second group key. In one aspect, the second authentication code is generated based on application of the second group key to the second application message. For example, the first authentication code is a first MAC, and the second authentication code is a second MAC. The second group key is received by the computing device from a second key service associated with the second geographic tile or the first wireless device positioned (or located) in the second geographic tile. In some cases, an edge of the second geographic tile is adjacent to a jurisdictional boundary, and wherein the second geographic tile is smaller than the first geographical tile.

In some aspects, determine the wireless device is positioned (or located) in the second geographic tile based on a validation of the second signature using the second group key. In some cases, the first group key is received from a first key service associated with the first geographic tile and the second group key is received from the first key service or a second key service associated with the second geographic tile. For example, the second key service may be associated with a different jurisdiction (e.g., country). In this case, the wireless device may be able to ascertain a corresponding tile. For example, the first group key and the second group key are identified based on geographic identifiers identifying the first geographical tile and the second geographic tile. A geographic identifier corresponds to a distinct geographic area or a distinct point of a corresponding geographic tile (e.g., a center point, etc.). In another example, the first geographic tile and the second geographic tile represent distinct geographic areas. In some aspects, the second group key may also be received from wireless devices within the second geographic tile.

In some cases, the first group key and the second group key each include an expiration time. In other cases, a wireless device of a geographic region can identify an expiration time associated with a corresponding group key based on a triggering event (e.g., a time duration, a number of wireless devices connecting in the geographic area since a key rotation event, etc.).

In some cases, the computing device may determine a current location is adjacent to the second geographic tile and transmit a key request message associated with the second geographic tile. A message is received based on the key request message including the second key.

In some cases, the computing device may determine a position corresponds to the second geographic tile and transmit a request to receive a third group key associated with a third geographic tile. The third geographic area is adjacent to the second geographic tile and not adjacent to the first geographic tile. In other aspects, the third geographic area may be proximate (e.g., not adjacent) and within communication range of the computing device. In some other cases, the third geographic area may be adjacent to the first geographic tile.

In some cases, the computing device may determine that application messages transmitted within the first geographic tile will add a third group key at a first time and transmit a second application message to the one or more wireless devices after the first time, the second application message being authenticated by a third group key associated with the first geographic tile. After the first time, the second application message can also be authenticated by the first group key. For example, the second application message can include a first MAC corresponding to the first group key and a second MAC corresponding to the third group key. In some cases, the computing device may receive information indicating a second time to request the third group key. In one example, the computing device can instruct another device to update its key. For example, the computing device may receive a second application message from a wireless device within the first geographic tile after the first time, determine the second application message is associated with the first group key, and based on the message from the wireless device, transmit a key update message to request a third group key associated with a current time slot. In some aspects, a key update message is a control message configured to request, trigger, and/or facilitate retrieval of an updated cryptographic key, including a new group key associated with a subsequent time slot or key rotation event.

In another example, the computing device may not have updated its key and may receive a message from a wireless device within the first geographic tile indicating the first group key is associated with a previous time slot. Based on the message from the wireless device, the computing device may transmit a key update message to request a third group key associated with a current time slot. As the change leader, the computing device may determine the first time for adding the third group key to the geographic tile and determine a second time (e.g., after the first time) for removing the first group key from the geographic tile. In some cases, the first time and the second time are fixed or dynamic based on environmental and traffic conditions within the first geographic tile. For example, fixed timing may include predetermined rotation intervals or scheduled key transition windows defined by system configuration. Dynamic timing may include adjustment of the addition or removal times based on observed device density, communication traffic volume, mobility patterns of wireless devices, network congestion, interference levels, and/or detected security conditions within the geographic tile.

The computing device may communicate using the updated key, for example, receiving a message from the first wireless device for the third group key between a third time and the first time after the first time and transmitting the third group key to the first wireless device before a time after the first time.

In some cases, the computing device may be a change leader, and may generate the third group key using a random number generator. For example, the computing device may determine to generate the third group key based on an assessment associated with at least one wireless device in the first geographic area.

In other aspects, a first key service associated with the first geographic tile is configured to generate the third group key.

In some cases, the computing device may determine a time slot between a third time and the first time for requesting the third group key.

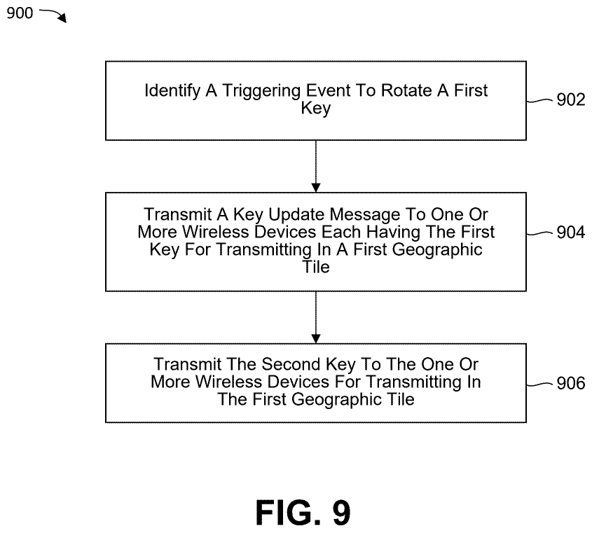

FIG. 9 is a flow diagram illustrating a process for rotating keys in a V2X communication in accordance with some aspects of the disclosure. The process 900 can be performed by a hardware device (or apparatus) or a component (e.g., one or more chipsets, a system-on-chip (SoC) of one or more processors or modules such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., a machine learning (ML) system such as a neural network model, any combination thereof, and/or other component or system) of the computing device. The operations of the process 900 may be implemented as hardware components that are executed based on software instructions run on one or more processors (e.g., CPU, GPU, DSP, NPU or neural engine, SoC, the processor 1010 of FIG. 10, and/or other processor(s)).

At block 902, the computing device may identify a triggering event associated with rotating a first key.

At block 904, the computing device may transmit a key rotation message to one or more wireless devices each having the first key for transmitting in a first geographic area.

At block 906, the computing device may transmit the second key to the one or more wireless devices for transmitting in the first geographic tile.

FIG. 10 is a block diagram illustrating an example of a computing system 1000, which may be employed for countermeasures against fault attacks on PQC schemes (e.g., digital signature schemes). In particular, FIG. 10 illustrates an example of computing system 1000, which can be, for example, any computing device making up an internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LiDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, an EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. For example, concurrent operation involves multiple tasks being performed independently over time and not necessarily simultaneously, while parallel operations involve multiple tasks executing simultaneously, such as on multiple processors or cores. In addition, the order of the operations may be rearranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special-purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smartphones, mobile phones, tablet devices, or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>;”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference is made to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, perform one or more of the methods described above. The computer-readable data storage medium may form part of a computer program product, which may include packaging materials. The computer-readable medium may include memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:
Aspect 1. An apparatus comprising: a memory; a processor coupled to the memory and configured to: transmit, while in a first geographic tile associated with a first group key, a first application message and a first authentication code to one or more wireless devices, wherein the first authentication code is generated based on application of the first group key to the first application message; and receive, while in the first geographic tile, a second application message and a second authentication code from a first wireless device located in a second geographic tile associated with a second group key, wherein the second authentication code is generated based on application of the second group key to the second application message.
Aspect 2. The apparatus of Aspect 1, wherein the first authentication code is a first message authentication code (MAC), and wherein the second authentication code is a second MAC.
Aspect 3. The apparatus of any of Aspects 1 to 2, wherein the processor is further configured to: determine the first wireless device is positioned in the second geographic tile based on information included in the second application message using the second group key.
Aspect 4. The apparatus of any of Aspects 1 to 3, wherein the processor is further configured to: receive, while in the first geographic tile, the second group key, wherein the second group key is encrypted using asymmetric encryption.
Aspect 5. The apparatus of Aspect 4, wherein the asymmetric encryption is associated with post-quantum cryptography (PQC).
Aspect 6. The apparatus of any of Aspects 1 to 5, wherein the first group key is received from a first key service associated with the first geographic tile and the second group key is received from the first key service or from a second key service associated with the second geographic tile.
Aspect 7. The apparatus of any of Aspects 1 to 6, wherein the first group key and the second group key are identified based on geographic identifiers identifying the first geographical tile and the second geographic tile, wherein a geographic identifier corresponds to a distinct geographic area or a distinct point in a corresponding geographic tile.
Aspect 8. The apparatus of any of Aspects 1 to 7, wherein the first geographic tile and the second geographic tile represent distinct geographic areas.
Aspect 9. The apparatus of any of Aspects 1 to 8, wherein the first group key and the second group key each include an expiration time.
Aspect 10. The apparatus of any of Aspects 8 to 9, wherein the processor is configured to: determine a current location is adjacent to the second geographic tile; and transmit a key request message associated with the second geographic tile, wherein a message in received based on the key request message including the second key.
Aspect 11. The apparatus of any of Aspects 1 to 10, wherein the second group key is received from a second key service associated with the second geographic tile.
Aspect 12. The apparatus of any of Aspects 1 to 11, wherein the second group key is received from the first wireless device located in the second geographic tile.
Aspect 13. The apparatus of any of Aspects 1 to 12, wherein the processor is configured to: decrypt the second application message or validate the second application message based on the second group key.
Aspect 14. The apparatus of any of Aspects 1 to 13, wherein the processor is configured to: determine a position corresponds to the second geographic tile; and transmit a request to receive a third group key associated with a third geographic tile.
Aspect 15. The apparatus of Aspect 14, wherein the third geographic tile is adjacent to the second geographic tile and not adjacent to the first geographic tile.
Aspect 16. The apparatus of any of Aspects 14 to 15, wherein the third geographic tile is adjacent to the first geographic tile.
Aspect 17. The apparatus of any of Aspects 1 to 16, wherein the processor is configured to: determine application messages transmitted within the first geographic tile will add a third group key at a first time; and transmit a second application message to the one or more wireless devices after the first time, the second application message being authenticated by at least a third group key associated with the first geographic tile.
Aspect 18. The apparatus of Aspect 17, wherein the processor is configured to: receive information indicating a second time to request the third group key.
Aspect 19. The apparatus of any of Aspects 17 to 18, wherein the second application message is also authenticated by the first group key.
Aspect 20. The apparatus of any of Aspects 17 to 19, wherein the processor is configured to: receive a second application message from a wireless device within the first geographic tile after the first time; determine the second application message is associated with the first group key; and based on the message from the wireless device, transmit a key update message to request a third group associated with a current time slot.
Aspect 21. The apparatus of any of Aspects 17 to 20, wherein the processor is configured to: receive a message from a wireless device within the first geographic tile indicating the first group key is associated with a previous time slot; and based on the message from the wireless device, transmit a key update message to request a third group associated with a current time slot.
Aspect 22. The apparatus of any of Aspects 17 to 21, wherein the processor is configured to: generate the third group key using a random number generator.
Aspect 23. The apparatus of any of Aspects 21 to 22, wherein the processor is configured to: determine to generate the third group key based on an assessment associated with one or more wireless devices in the first geographic area.
Aspect 24. The apparatus of any of Aspects 17 to 23, wherein a first key service associated with the first geographic tile is configured to generate the third group key.
Aspect 25. The apparatus of any of Aspects 17 to 24, wherein the processor is configured to: determine the first time for changing to the third group key; and determine a second time after the first time for removing the first group key.
Aspect 26. The apparatus of Aspect 25, wherein the first time and the second time are fixed or dynamic based on environmental and traffic conditions within the first geographical tile.
Aspect 27. The apparatus of any of Aspects 25 to 26, wherein the processor is configured to: receive a request from the first wireless device for the third group key between a third time and the first time after the first time; and transmit the third group key to the first wireless device before the first time.
Aspect 28. The apparatus of any of Aspects 25 to 27, wherein the processor is configured to: determine a timeslot between a third time and the first time for requesting the third group key.
Aspect 29. The apparatus of any of Aspects 1 to 28, wherein the memory is configured to store group keys associated with each geographic tile that borders the first geographic tile.
Aspect 30. The apparatus of any of Aspects 1 to 29, wherein an edge of the second geographic tile is adjacent to a jurisdictional boundary, and wherein the second geographic tile is smaller than the first geographical tile.
Aspect 31. An apparatus comprising: a memory; a processor connected to the wireless communication device and configured to: identify a triggering event associated with a first key; transmit a key rotation message to one or more wireless devices each having a first key for transmitting in a first geographic area; generate a second key associated with the second geographic area; and transmit the second key to the one or more wireless devices.

What is claimed is:

1. An apparatus comprising:
a memory; and
a processor coupled to the memory and configured to:
transmit, while in a first geographic tile associated with a first group key used by wireless devices within the first geographic tile, a first application message and a first authentication code to one or more wireless devices, wherein the first authentication code is generated based on application of the first group key to the first application message; and
receive, while in the first geographic tile, a second application message and a second authentication code from a first wireless device located in a second geographic tile associated with a second group key, wherein the second authentication code is generated based on application of the second group key to the second application message.

2. The apparatus of claim 1, wherein the first authentication code is a first message authentication code (MAC), and wherein the second authentication code is a second MAC.

3. The apparatus of claim 1, wherein the processor is further configured to:
determine the first wireless device is positioned in the second geographic tile based on information included in the second application message using the second group key.

4. The apparatus of claim 1, wherein the processor is further configured to:
receive, while in the first geographic tile, the second group key, wherein the second group key is encrypted using asymmetric encryption.

5. The apparatus of claim 1, wherein the first group key is received from a first key service associated with the first geographic tile and the second group key is received from the first key service associated with the first geographic tile or from a second key service associated with the second geographic tile.

6. The apparatus of claim 1, wherein the first group key and the second group key are identified based on geographic identifiers identifying the first geographic tile and the second geographic tile, wherein a geographic identifier corresponds to a distinct geographic area or a distinct point in a corresponding geographic tile.

7. The apparatus of claim 1, wherein the processor is configured to:
determine a current location is adjacent to the second geographic tile;
receive a message based on a key request message including the second group key; and
transmit the key request message associated with the second geographic tile.

8. The apparatus of claim 1, wherein the processor is configured to:
decrypt the second application message or validate the second application message based on the second group key.

9. The apparatus of claim 1, wherein the processor is configured to:
determine a position corresponds to the second geographic tile; and
transmit a request to receive a third group key associated with a third geographic tile while the position is within the second geographic tile.

10. The apparatus of claim 1, wherein the processor is configured to:
determine application messages transmitted within the first geographic tile are to be authenticated using a third group key associated with the first geographic tile; and
transmit the second application message to the one or more wireless devices after a first time, the second application message being authenticated using at least the third group key.

11. The apparatus of claim 10, wherein the processor is configured to:
receive information indicating a second time to request the third group key associated with a key rotation.

12. The apparatus of claim 10, wherein the processor is configured to:
receive the second application message from a wireless device within the first geographic tile after the first time;
determine the second application message is associated with the first group key; and
based on the second application message from the wireless device, transmit a key update message to request the third group key associated with a current time slot.

13. The apparatus of claim 12, wherein the processor is configured to:
receive a message from a wireless device within the first geographic tile indicating the first group key is associated with a previous time slot; and
based on the message from the wireless device, transmit the key update message to request the third group key associated with the current time slot.

14. The apparatus of claim 10, wherein the processor is configured to:
generate the third group key using a random number generator.

15. The apparatus of claim 10, wherein the processor is configured to:
determine to generate the third group key based on conditions of the one or more wireless devices in the first geographic tile.

16. The apparatus of claim 10, wherein the processor is configured to:
determine the first time to begin the third group key based on a key rotation; and
determine an expiration time for removing the first group key after the key rotation.

17. The apparatus of claim 16, wherein the processor is configured to determine whether timing of a key rotation window, including the first time and a second time, is fixed or dynamic based on at least one of environmental conditions or traffic conditions within the first geographic tile.

18. The apparatus of claim 16, wherein the processor is configured to:
receive a request from the first wireless device for the third group key during a key rotation window preceding the first time; and
transmit the third group key to the first wireless device before the first time.

19. The apparatus of claim 16, wherein the processor is configured to:
determine a timeslot between a third time and the first time for requesting the third group key.

20. An apparatus comprising:
a memory; and
a processor coupled to the memory and configured to:
identify a triggering event associated with a first key;
transmit a key rotation message to one or more wireless devices each having the first key for transmitting in a first geographic area;
generate a second key associated with a second geographic area; and
transmit the second key to the one or more wireless devices.
